(19) United States
(12) Patent Application Publication
(10) Pub. No.: US 2026/0308051 A1
(43) Pub. Date: Oct. 8, 2026

(54) CEMENTITOUS COMPOSITIONS FOR REDUCING EFFLORESCENCE

(71) Applicant: Tremco CPG Inc., Beachwood, OH (US)

(72) Inventors: Humayun MANDAL, Warwick, RI (US); Patrick MOQUIN, Bellingham, MA (US)

(73) Assignee: Tremco CPG Inc., Beachwood, OH (US)

(21) Appl. No.: 19/482,312

(22) PCT Filed: May 7, 2024
(86) PCT No.: PCT/US2024/028090

§ 371 Date: Nov. 7, 2025

Related U.S. Application Data
(60) Provisional application No. 63/501,271, filed on May 10, 2023.

(51) Int. Cl. C04B 7/02; C04B 7/32; C04B 14/06; C04B 18/14; C04B 24/14; C04B 28/04; C04B 28/06; C04B 40/06; C04B 103/00; C04B 103/46

(52) U.S. Cl. CPC C04B 7/02; C04B 7/323; C04B 14/06; C04B 18/146; C04B 24/14; C04B 28/04; C04B 28/065; C04B 40/0608; C04B 2103/0001; C04B 2103/465

(57) ABSTRACT

Various cementitious dry mixes include a Portland cement, a calcium aluminate cement, a calcium sulfo-aluminate cement, an admixture comprising a hydrophilic additive, and carbonic anhydrase. The hydrophilic additive can be, for example, hydrophilic fumed silica. Cementitious compositions formed from the cementitious dry mixes and cured cement products formed from the same are also disclosed.

### CROSS-REFERENCE TO RELATED APPLICATIONS

This application claims priority to and all benefit of U.S. Provisional Application Ser. No. 63/501,271, filed May 10, 2023, the entire contents of which is fully incorporated herein by reference.

### BACKGROUND

Various cement compositions include calcium silicate and calcium aluminate that hydrate to form calcium-silicate-hydrates, the cementitious binding phase, and calcium hydroxide. The calcium silicate hydrate phases are responsible for most of the strength development of the cement. The calcium hydroxide can be leached to the surface where it carbonates to form discoloring deposits known as efflorescence. In addition to discoloring the cement, the leaching increases the porosity, which in turn, can make the cement more susceptible to infiltration and attack.

The efflorescence imparts an irregular chalk-like appearance to the surface of cured cement, which is unattractive and makes it difficult to achieve a uniform color in manufactured cement products. Accordingly, there is a need for cement products that exhibit reduced efflorescence.

### SUMMARY

In aspects of the present disclosure, a cementitious dry mix includes a Portland cement, a calcium aluminate cement, a calcium sulfo-aluminate cement, an admixture comprising a hydrophilic additive, and carbonic anhydrase.

In some aspects, a cementitious dry mix includes the cementitious dry mix of the previous aspect, wherein the hydrophilic additive is selected from the group consisting of hydrophilic: precipitated silica, fumed silica, silica fume, magnesium hydroxide, lithium hydroxide, sodium sulfate, zinc sulfate, magnesium sulfate, and combinations thereof.

In some aspects, a cementitious dry mix includes the cementitious dry mix of any one of the previous aspects, wherein the hydrophilic additive is hydrophilic fumed silica.

In some aspects, a cementitious dry mix includes the cementitious dry mix of any one of the previous aspects, further comprising an aggregate.

In some aspects, a cementitious dry mix includes the cementitious dry mix of any one of the previous aspects, wherein the aggregate is present in an amount of from 30 wt. % to 80 wt. % based on a total weight of the cementitious dry mix.

In some aspects, a cementitious dry mix includes the cementitious dry mix of any one of the previous aspects, wherein the carbonic anhydrase is present in an amount of from 0.1 ppm to 1000 ppm based on a total weight of the cementitious dry mix.

In some aspects, a cementitious dry mix includes the cementitious dry mix of any one of the previous aspects, wherein the hydrophilic additive is present in an amount of from 0.1 wt. % to 20 wt. % based on a total weight of the cementitious dry mix.

In some aspects, a cementitious composition is prepared from the cementitious dry mix of any one of the previous aspects, further comprising from about 15 wt. % to about 40 wt. % water of hydration based on the total weight of the cementitious dry mix.

In some aspects, a cementitious composition includes the cementitious composition of the previous aspect, wherein the cementitious composition has an open time of less than or equal to about 120 minutes.

In some aspects, a cementitious composition includes the cementitious composition of the previous aspect, wherein the cementitious composition has a dry time of less than or equal to about 8 hours.

In aspects of the present disclosure, a cured cement product is formed from a cementitious dry mix comprising a Portland cement, a calcium aluminate cement, a calcium sulfo-aluminate cement, an admixture comprising a hydrophilic additive, and carbonic anhydrase.

In some aspects, a cured cement product includes a cured cement product formed from the cementitious dry mix according to any one of the previous aspects, wherein the hydrophilic additive is selected from the group consisting of hydrophilic: precipitated silica, fumed silica, silica fume, magnesium hydroxide, lithium hydroxide, sodium sulfate, zinc sulfate, magnesium sulfate, and combinations thereof.

In some aspects, a cured cement product includes a cured cement product formed from the cementitious dry mix according to any one of the previous aspects, wherein the hydrophilic additive is hydrophilic fumed silica.

In some aspects, a cured cement product includes a cured cement product formed from the cementitious dry mix according to any one of the previous aspects, wherein the cementitious dry mix further comprises an aggregate.

In some aspects, a cured cement product includes a cured cement product formed from the cementitious dry mix according to any one of the previous aspects, wherein the aggregate is present in an amount of from 30 wt. % to 80 wt. % based on a total weight of the cementitious dry mix.

In some aspects, a cured cement product includes a cured cement product formed from the cementitious dry mix according to any one of the previous aspects, wherein the carbonic anhydrase is present in an amount of from 0.1 ppm to 1000 ppm based on a total weight of the cementitious dry mix.

In some aspects, a cured cement product includes a cured cement product formed from the cementitious dry mix according to any one of the previous aspects, wherein the hydrophilic additive is present in an amount of from 0.1 wt. % to 20 wt. % based on a total weight of the cementitious dry mix.

In some aspects, a cured cement product includes a cured cement product formed from the cementitious dry mix according to any one of the previous aspects, wherein the cured cement product has a porosity of less than about 25%.

In some aspects, a cured cement product includes a cured cement product formed from the cementitious dry mix according to any one of the previous aspects, wherein the cured cement product has a porosity of less than about 21%.

In some aspects, a cured cement product includes a cured cement product formed from the cementitious dry mix according to any one of the previous aspects, wherein the cured cement product exhibits reduced efflorescence as compared to a cured cement product made from a cementitious composition that does not include the hydrophilic additive, the carbonic anhydrase, or both, but is otherwise identical.

In some aspects, a cementitious dry mix includes the cementitious dry mix of any one of the previous aspects, wherein the aggregate comprises sand.

In some aspects, a cured cement product includes a cured cement product formed from the cementitious dry mix according to any one of the previous aspects, wherein the aggregate comprises sand.

### BRIEF DESCRIPTION OF THE DRAWINGS

FIG. 1 is a graph showing the viscosity (y-axis, in PU) as a function of time (x-axis, in minutes) for various cementitious compositions as set forth in Example 1;

FIG. 2 is a photograph showing efflorescence of various cementitious compositions as set forth in Example 2;

FIG. 3 is a photograph showing efflorescence of various cementitious compositions having a varying loading of carbonic anhydrase as set forth in Example 2;

FIG. 4 is a photograph showing efflorescence of various cementitious compositions having fumed silica of various surface areas as set forth in Example 3;

FIG. 5 is an x-ray diffraction (XRD) spectrogram for an unexposed sample formed from the cementitious composition of Comparative Sample E;

FIG. 6 is an XRD spectrogram for an unexposed sample formed from the cementitious composition of Comparative Sample F;

FIG. 7 is an XRD spectrogram for an unexposed sample formed from the cementitious composition of Comparative Sample G;

FIG. 8 is an XRD spectrogram for an unexposed sample formed from the cementitious composition of Comparative Sample H;

FIG. 9 is an XRD spectrogram for an unexposed sample formed from the cementitious composition of Sample 5 and in accordance with various aspects described herein;

FIG. 10 is a backscattered electron (BSE) signal image obtained using scanning electron microscopy (SEM) for a sample formed from the cementitious composition of Comparative Sample E;

FIG. 11 is a BSE signal image obtained using SEM for a sample formed from the cementitious composition of Comparative Sample F;

FIG. 12 is a BSE signal image obtained using SEM for a sample formed from the cementitious composition of Comparative Sample G;

FIG. 13 is a BSE signal image obtained using SEM for a sample formed from the cementitious composition of Comparative Sample H;

FIG. 14 is a BSE signal image obtained using SEM for a sample formed from the cementitious composition of Sample 5 and in accordance with various aspects described herein;

FIG. 15 is an x-ray microscopy (XRM) image obtained for a sample formed from the cementitious composition of Comparative Sample E;

FIG. 16 is an XRM image obtained for a sample formed from the cementitious composition of Comparative Sample F;

FIG. 17 is an XRM image obtained for a sample formed from the cementitious composition of Comparative Sample G;

FIG. 18 is an XRM image obtained for a sample formed from the cementitious composition of Comparative Sample H; and

FIG. 19 is an XRM image obtained for a sample formed from the cementitious composition of Sample 5 and in accordance with various aspects described herein.

### DETAILED DESCRIPTION

The present disclosure provides a cementitious composition including a combination of Portland cement, calcium aluminate cement, and calcium sulfo-aluminate cement; carbonic anhydrase; and an admixture comprising a hydrophilic additive. In various aspects, the hydrophilic additive is selected from the group consisting of hydrophilic precipitated silica, fumed silica, silica fume, magnesium hydroxide, lithium hydroxide, sodium sulfate, zinc sulfate, magnesium sulfate, and combinations thereof. As will be described in greater detail herein, the inclusion of the hydrophilic additive in combination with the carbonic anhydrase enzyme can be effective to increase mitigation of efflorescence as compared to the use of carbonic anhydrase alone. Other advantages will be described in accordance with various aspects herein.

### Cement Dry Mix

According to various aspects, the cementitious composition includes a cement dry mix (or “dry mix”) that includes one or more cements with an aggregate and an admixture. Although combination of the dry components of the cementitious composition into a cement dry mix is described in various aspects, it should be understood that other orders of combination can be employed, and the dry components described as being included in the cement dry mix can be added separately to the cementitious composition instead of as a homogenous mixture.

The one or more cements included in the dry mix can include one or more hydraulic cement binders. The phrase “hydraulic cement binder,” as used herein, refers to cements which harden when mixed with water. Suitable hydraulic cements include Portland cement, Portland cement blends (e.g., Portland blast furnace cement, Portland fly ash cement, Portland pozzolan cement, etc.), pozzolan-lime cements, slag-lime cements, supersulfated cement, calcium aluminate cement, calcium sulfo-aluminate cement, “natural” cement, and geopolymer cements. Other suitable hydraulic cements known and used in the art can additionally or alternatively be incorporated into the dry mix.

In various aspects, the dry mix includes more than one type of hydraulic cement binder. For example, in some aspects, the cement dry mix includes two, three, or even four or more types of hydraulic cements. Without being bound by theory, it is believed that the combination of various types of hydraulic cement can speed up the cement curing process, thereby enabling the hydrated cement to gain handling strength faster than if ordinary Portland cement alone was used. In one particular aspect, the dry mix includes a Portland cement, a calcium aluminate cement, and a calcium sulfo-aluminate cement. Each of the cements can be included in the same relative amounts as the other cement(s), or each cement can be included in a different amount as the other cement(s).

In various aspects, the hydraulic cement binders are present in the dry mix in a total amount of from about 10 wt. % to about 60 wt. % based on a total weight of the dry mix. For example, the hydraulic cement binders can be present in the dry mix in an amount of from about 10 wt. % to about 60 wt. %, from about 10 wt. % to about 50 wt. %, from about 10 wt. % to about 40 wt. %, from about 10 wt. % to about 30 wt. %, from about 15 wt. % to about 60 wt. %, from about 15 wt. % to about 50 wt. %, from about 15 wt. % to about 40 wt. %, from about 15 wt. % to about 30 wt. %, from about 20 wt. % to about 60 wt. %, from about 20 wt. % to about 50 wt. %, from about 20 wt. % to about 40 wt. %, from about 20 wt. % to about 30 wt. %, from about 25 wt. % to about 60 wt. %, from about 25 wt. % to about 50 wt. %, from about 25 wt. % to about 40 wt. %, from about 25 wt. % to about 30 wt. %, from about 30 wt. % to about 60 wt. %, from about 30 wt. % to about 50 wt. %, or even from about 30 wt. % to about 40 wt. %, including any and all ranges and sub-ranges therein.

The dry mix further includes an aggregate. Aggregates include inert granular materials such as, by way of example and not limitation, sand, gravel, slag, recycled concrete, limestone, silica, and/or crushed stone. Aggregates can limit the shrinkage of the cement upon curing and can provide bulk to the cement composition in a cost-effective manner. In various aspects, sand is included in the dry mix as an aggregate. However, it is contemplated that other aggregates or combinations of aggregates can be included in the dry mix.

In various aspects, the aggregate has a maximum particle size of from about 1 μm to about 1000 μm, from about 1 μm to about 750 μm, from about 1 μm to about 500 μm, from about 5 μm to about 1000 μm, from about 5 μm to about 750 μm, from about 5 μm to about 500 μm, from about 10 μm to about 1000 μm, from about 10 μm to about 750 μm, from about 10 μm to about 500 μm, from about 20 μm to about 1000 μm, from about 20 μm to about 750 μm, or from about 20 μm to about 500 μm, including any and all ranges and subranges therein. As used herein, the “maximum particle size” refers to the largest dimension of the particle.

In various aspects, the aggregate is present in the dry mix in an amount of from about 30 wt. % to about 80 wt. % based on a total weight of the dry mix. For example, the aggregate can be present in the dry mix in an amount of from about 30 wt. % to about 80 wt. %, from about 30 wt. % to about 75 wt. %, from about 30 wt. % to about 70 wt. %, from about 30 wt. % to about 65 wt. %, from about 30 wt. % to about 60 wt. %, from about 35 wt. % to about 80 wt. %, from about 35 wt. % to about 75 wt. %, from about 35 wt. % to about 70 wt. %, from about 35 wt. % to about 65 wt. %, from about 35 wt. % to about 60 wt. %, from about 40 wt. % to about 80 wt. %, from about 40 wt. % to about 75 wt. %, from about 40 wt. % to about 70 wt. %, from about 40 wt. % to about 65 wt. %, from about 40 wt. % to about 60 wt. %, from about 45 wt. % to about 80 wt. %, from about 45 wt. % to about 75 wt. %, from about 45 wt. % to about 70 wt. %, from about 45 wt. % to about 65 wt. %, from about 45 wt. % to about 60 wt. %, from about 50 wt. % to about 80 wt. %, from about 50 wt. % to about 75 wt. %, from about 50 wt. % to about 70 wt. %, from about 50 wt. % to about 65 wt. %, or even from about 50 wt. % to about 60 wt. %, including any and all ranges and sub-ranges therein.

In addition to the cement and the aggregate, the dry mix includes an admixture. Cement admixtures include the dry ingredients (e.g., organic and inorganic materials) in the concrete other than the cement and aggregate that can be used to enhance or modify one or more properties of the cement, such as workability, durability, strength, or color. In some aspects, the admixture can be used to control cement cure rate, retain water in the cement matrix, reduce shrinkage, and enhance durability of the finished cement. Thus, the particular admixture can vary depending on the application or final desired properties of the cement. In various aspects, the admixture includes a cure speed accelerator or retarder, fillers, extenders, water reducers, rheology modifiers, redispersible polymer powders including those based on acrylic polymers, vinyl acetate ethylene copolymers, vinyl acetate, ethylene and vinyl ester terpolymers, and combinations thereof.

In general, the admixture is included in the dry mix in an amount of from about 5 wt. % to about 40 wt. % based on the total weight of the dry mix. For example, the admixture can be included in the dry mix in an amount of from about 5 wt. % to about 40 wt. %, from about 5 wt. % to about 35 wt. %, from about 5 wt. % to about 30 wt. %, from about 5 wt. % to about 25 wt. %, from about 10 wt. % to about 40 wt. %, from about 10 wt. % to about 35 wt. %, from about 10 wt. % to about 30 wt. %, from about 10 wt. % to about 25 wt. %, from about 15 wt. % to about 40 wt. %, from about 15 wt. % to about 35 wt. %, from about 15 wt. % to about 30 wt. %, from about 15 wt. % to about 25 wt. %, from about 20 wt. % to about 40 wt. %, from about 20 wt. % to about 35 wt. %, from about 20 wt. % to about 30 wt. %, or even from about 20 wt. % to about 25 wt. %, including any and all ranges and sub-ranges therein.

In various aspects, the admixture includes at least one hydrophilic additive. According to various aspects, the hydrophilic additive is selected from the group consisting of hydrophilic precipitated silica, fumed silica, silica fume, magnesium hydroxide, lithium hydroxide, sodium sulfate, zinc sulfate, magnesium sulfate, or combinations thereof. Other hydrophilic additives are possible and contemplated. In one particular aspect, the hydrophilic additive is hydrophilic fumed silica.

The hydrophilic additive is included in the admixture such that the hydrophilic additive is present in an amount of about 0.1 wt. % to about 20 wt. % based on a total weight of the dry mix. For example, the hydrophilic additive can be included in the dry mix in an amount of from about 0.1 wt. % to about 20 wt. %, from about 0.1 wt. % to about 15 wt. %, from about 0.1 wt. % to about 10 wt. %, from about 0.1 wt. % to about 5 wt. %, from about 0.5 wt. % to about 20 wt. %, from about 0.5 wt. % to about 15 wt. %, from about 0.5 wt. % to about 10 wt. %, from about 0.5 wt. % to about 5 wt. %, from about 1 wt. % to about 20 wt. %, from about 1 wt. % to about 15 wt. %, from about 1 wt. % to about 10 wt. %, from about 1 wt. % to about 5 wt. %, from about 5 wt. % to about 20 wt. %, from about 5 wt. % to about 15 wt. %, or even from about 5 wt. % to about 10 wt. %, including any and all ranges and sub-ranges therein.

To prepare the dry mix, the dry materials (e.g., the cement, the aggregate, and the admixture) are added to a container and mixed to provide a homogenous dry mixture. The mixing can be carried out according to any method known and used in the art, including using a mixer or shaker to combine the materials.

### Carbonic Anhydrase

The cementitious composition of the present disclosure includes carbonic anhydrase. Carbonic anhydrase (CA) is a calcium carbonate precipitating enzyme which catalyzes the reaction between carbon dioxide (CO₂) and water (H₂O) to form carbonic acid (H₂CO₃), which in turn dissociates forming bicarbonate (HCO₃) and protons, depending on the pH, as shown in equation (1):

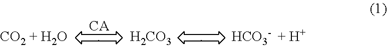

The carbonic anhydrase is added to the cementitious composition in lyophilized powder form in various aspects. According to various aspects, the carbonic anhydrase is present in an amount of from about 0.1 ppm to about 1000 ppm based on a total weight of the dry mix. For example, the carbonic anhydrase can be included in the cementitious composition in an amount of from about 0.1 ppm to about 1000 ppm, from about 0.1 ppm to about 750 ppm, from about 0.1 ppm to about 500 ppm, from about 0.1 ppm to about 250 ppm, from about 0.1 ppm to about 100 ppm, from about 0.1 ppm to about 50 ppm, from about 0.5 ppm to about 1000 ppm, from about 0.5 ppm to about 750 ppm, from about 0.5 ppm to about 500 ppm, from about 0.5 ppm to about 250 ppm, from about 0.5 ppm to about 100 ppm, from about 0.5 ppm to about 50 ppm, from about 1 ppm to about 1000 ppm, from about 1 ppm to about 750 ppm, from about 1 ppm to about 500 ppm, from about 1 ppm to about 250 ppm, from about 1 ppm to about 100 ppm, from about 1 ppm to about 50 ppm, from about 5 ppm to about 1000 ppm, from about 5 ppm to about 750 ppm, from about 5 ppm to about 500 ppm, from about 5 ppm to about 250 ppm, from about 5 ppm to about 100 ppm, from about 5 ppm to about 50 ppm, from about 10 ppm to about 1000 ppm, from about 10 ppm to about 750 ppm, from about 10 ppm to about 500 ppm, from about 10 ppm to about 250 ppm, from about 10 ppm to about 100 ppm, from about 10 ppm to about 50 ppm, from about 30 ppm to about 1000 ppm, from about 30 ppm to about 750 ppm, from about 30 ppm to about 500 ppm, from about 30 ppm to about 250 ppm, from about 30 ppm to about 100 ppm, or even from about 30 ppm to about 50 ppm, including any and all ranges and subranges therein. As described hereinabove, the carbonic anhydrase can be added to the cement dry mix in powdered form, or it can be added to water of hydration prior to mixing with the cement dry mix.

Without being bound by theory, it is believed that the bicarbonate (HCO₃) that is formed as a result of the catalyzed reaction between CO₂ and water reacts with calcium ions present in the cement to form calcium carbonate, as shown in equation (2):

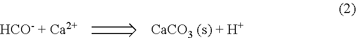

The insoluble calcium carbonate is believed to plug the pores and/or capillaries in the cured cement, thus reducing porosity and the concentration of free calcium ions, which is, in turn, believed to reduce or even prevent efflorescence that would normally occur in the cement from the migration of calcium ions through the pores of the cement to react with carbon dioxide in the presence of moisture in the ambient air at the surface to form the calcium carbonate (e.g., efflorescence). Moreover, in some aspects, the use of carbonic anhydrase is believed to reduce cure time, but not the open time of the cement.

Unexpectedly, in various aspects of the present disclosure, the inclusion of the hydrophilic additive (e.g., hydrophilic fumed silica) along with carbonic anhydrase can increase the mitigation of efflorescence as compared to the use of carbonic anhydrase alone. It is believed that the carbonic anhydrase enzyme catalyzes a reaction of the hydrophilic additive with the calcium ions in the cement to form calcium silicate hydrates, which can plug the pores and capillaries of the cementitious matrix, thereby contributing to the mitigation of the efflorescence by preventing the transfer of water through the cured cementitious matrix.

### Cementitious Composition

According to various aspects, the cementitious composition is made by combining the cement dry mix (e.g., the one or more cements, the aggregate, the admixture) and the carbonic anhydrase with water of hydration. In aspects, the water of hydration is added in an amount of from about 15 wt. % to about 40 wt. % based on the total weight of the cementitious composition. For example, the water of hydration can be added in an amount of from about 15 wt. % to about 40 wt. %, from about 15 wt. % to about 35 wt. %, from about 15 wt. % to about 30 wt. %, from about 15 wt. % to about 25 wt. %, from about 20 wt. % to about 40 wt. %, from about 20 wt. % to about 35 wt. %, from about 20 wt. % to about 30 wt. %, from about 20 wt. % to about 25 wt. %, from about 25 wt. % to about 40 wt. %, from about 25 wt. % to about 35 wt. %, or even from about 25 wt. % to about 30 wt. %, including any and all ranges and sub-ranges therein. As described in greater detail above, the carbonic anhydrase can be pre-mixed with the cement dry mix or can be added to the water of hydration prior to combining with the cement dry mix.

In various aspects, the cementitious composition has an open time of less than or equal to about 120 minutes. Open time is defined as the time when the dry mixture is added to water and mixed to form a homogeneous wet mixture until the time when the wet mixture reaches the maximum measurable viscosity. For example, the cementitious composition has an open time of from about 15 minutes to about 120 minutes, from about 15 minutes to about 110 minutes, from about 15 minutes to about 100 minutes, from about 15 minutes to about 90 minutes, from about 15 minutes to about 80 minutes, from about 15 minutes to about 70 minutes, from about 15 minutes to about 60 minutes, from about 15 minutes to about 50 minutes, from about 15 minutes to about 40 minutes, from about 15 minutes to about 30 minutes, from about 15 minutes to about 28 minutes, from about 18 minutes to about 120 minutes, from about 18 minutes to about 110 minutes, from about 18 minutes to about 100 minutes, from about 18 minutes to about 90 minutes, from about 18 minutes to about 80 minutes, from about 18 minutes to about 70 minutes, from about 18 minutes to about 60 minutes, from about 18 minutes to about 50 minutes, from about 18 minutes to about 40 minutes, from about 18 minutes to about 30 minutes, from about 18 minutes to about 28 minutes, from about 20 minutes to about 120 minutes, from about 20 minutes to about 110 minutes, from about 20 minutes to about 100 minutes, from about 20 minutes to about 90 minutes, from about 20 minutes to about 80 minutes, from about 20 minutes to about 70 minutes, from about 20 minutes to about 60 minutes, from about 20 minutes to about 50 minutes, from about 20 minutes to about 40 minutes, from about 20 minutes to about 30 minutes, or from about 20 minutes to about 28 minutes, including any and all ranges and sub-ranges therein. In some aspects, the open time of the cementitious composition is comparable to a cementitious composition that does not include carbonic anhydrase and a hydrophilic additive but is otherwise identical.

In various aspects, the cementitious composition has a dry time of less than or equal to about 8 hours. The dry time is the amount of time between the addition of the cement dry mix to the water of hydration and when the hardness reaches a durometer hardness of 85 on the Shore A durometer scale. For example, the cementitious composition can have a dry time of from about 2 hours to about 8 hours, from about 2 hours to about 7 hours, from about 2 hours to about 6 hours, from about 2 hours to about 5 hours, from about 2 hours to about 4 hours, from about 2 hours to about 3.5 hours, from about 2.5 hours to about 8 hours, from about 2.5 hours to about 7 hours, from about 2.5 hours to about 6 hours, from about 2.5 hours to about 5 hours, from about 2.5 hours to about 4 hours, from about 2.5 hours to about 3.5 hours, from about 3 hours to about 8 hours, from about 3 hours to about 7 hours, from about 3 hours to about 6 hours, from about 3 hours to about 5 hours, from about 3 hours to about 4 hours, or from about 3 hours to about 3.5 hours, including any and all ranges and sub-ranges therein.

In accordance with various aspects, cured cement products formed from the cementitious compositions described herein can exhibit reduced efflorescence, reduced dry time, and reduced porosity while maintaining a comparable open time as compared to otherwise identical cementitious compositions that do not include carbonic anhydrase, a hydrophilic additive, or both. In various aspects, the cured cement product formed from the cementitious compositions of the present disclosure have a porosity of less than about 25%, including less than 21%, including less than 19%, and including less than 15% as determined by the XRM method disclosed in the examples herein. As such, cured cement products formed from the cementitious compositions described herein can be more uniform in color, particularly over time.

### EXAMPLES

The following examples are included for the purposes of illustration and do not limit the general inventive concepts described herein.

### Example 1

Cement dry mixes were prepared by mixing approximately 10 wt. % ordinary Portland cement, approximately 10 wt. % calcium aluminate cement, and approximately 10 wt. % calcium sulfo-aluminate cement with approximately 45 wt. % sand and approximately 25 wt. % admixture (all wt. % based on the total weight of the dry mix). The admixture included cure speed accelerator and retarder, fillers (including hydrophilic fumed silica), extenders, rheology modifiers, water reducing agent, and redispersible polymer powders based on acrylic polymers, vinyl acetate ethylene copolymers, and vinyl acetate, ethylene and vinyl ester terpolymers. A combination of red, yellow and black powdered pigments with a total weight of up to 5% based on the weight of the dry mix was post-added to impart red color to the cured cement product. An electric hand-held drill mixer was used to mix the dry cement binders to get a homogeneous dry mixture. The homogeneous dry mixture was slowly added to approximately 20-30 wt. % water of hydration based on the total weight of the dry mixture and mixed for between 2 and 5 minutes using the electric drill mixer. Various samples were prepared using different grades of hydrophilic fumed silica (commercially available as Wacker HDK N20) at a constant loading of approximately 1 wt. % based on the total weight of the cement dry mix along with a constant loading of approximately 40 ppm carbonic anhydrase. In examples including carbonic anhydrase, the carbonic anhydrase was a carbonic anhydrase from bovine erythrocytes added to the water of hydration before mixing with the dry mixture. Comparative samples were prepared using no carbonic anhydrase (i.e., with hydrophilic fumed silica per above), carbonic anhydrase alone (i.e., with no hydrophilic fumed silica per above), or carbonic anhydrase with hydrophobic fumed silica (i.e., with hydrophobic fumed silica replacing the hydrophilic fumed silica at same loading per above). The compositions of each of the samples and comparative samples are provided in Table 1 below.

TABLE 1

| | Carbonic Anhydrase | Fumed Silica |
|---|---|---|
| Comparative Sample A | No | No |
| Comparative Sample B | Yes | No |
| Comparative Sample C | Yes | Hydrophobic 1 |
| Comparative Sample D | Yes | Hydrophobic 2 |
| Sample 1 | Yes | Hydrophilic 1 |
| Sample 2 | Yes | Hydrophilic 2 |
| Sample 3 | Yes | Hydrophilic 3 |
| Sample 4 | Yes | Hydrophilic 4 |

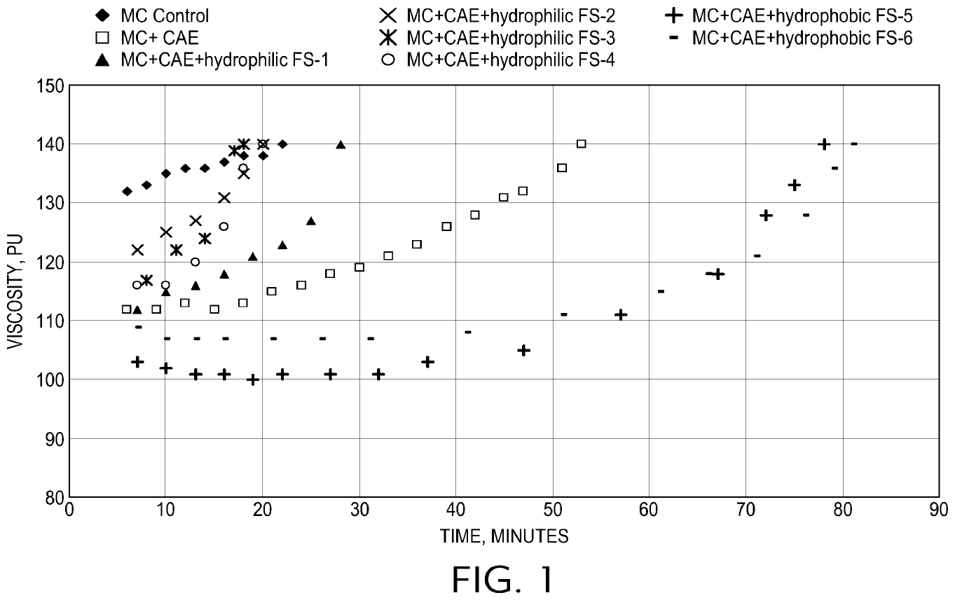

Viscosity of the wet cement mixes was measured using a Brookfield KU-2 viscometer to evaluate open times (e.g., working times when the cement mixture is still in a plastic state). As disclosed herein, open time is defined as the time when the dry mixture is added to water and mixed to form a homogeneous wet mixture until the time when the wet mixture reaches the maximum measurable viscosity. The viscosity is measured at certain time intervals until it reaches 140 or cannot be read on the KU-2 viscometer. The viscosities (y-axis; in PU) as a function of time (x-axis; in minutes) are shown in FIG. 1.

As shown in FIG. 1, open times were faster for the samples including hydrophilic fumed silica in combination with the carbonic anhydrase enzyme as compared to the comparative samples including hydrophobic fumed silica (Comparative Samples C and D) and for Comparative Sample B including the carbonic anhydrase alone.

Dry time of the specimens was measured by measuring the durometer hardness of the dry film periodically until the hardness reaches a durometer hardness of 85 on the Shore A scale. The dry time is considered to be the time at which the cement matrix achieves sufficient strength for handling and is an indication of how fast the cement mixture is curing. The shorter the dry time, the faster the cure rate of the cement mixture. Dry time is reported in Table 2 below.

TABLE 2

| | Open Time | Dry Time | |
|---|---|---|---|
| Comparative Sample A | 22 min | 3 | h |
| Comparative Sample B | 53 min | 4 | h |
| Comparative Sample C | 78 min | 6 | h |
| Comparative Sample D | 81 min | 5.5 | h |
| Sample 1 | 28 min | 3.5 | h |
| Sample 2 | 20 min | 2.5 | h |
| Sample 3 | 18 min | 3 | h |
| Sample 4 | 20 min | 4 | h |

### Example 2

Wet mixtures of the cementitious compositions were troweled onto 6 inch×9 inch expanded polystyrene (EPS) foam with wax papers and panzer glass fiber mesh to a thickness of 3/16 inch. The compositions of each of the cementitious compositions are reported in Table 3 below. For compositions that included carbonic anhydrase, the enzyme was loaded at 100 ppm. The cement dry mix was as described above in Example 1. After drying the samples for 24 hours at room temperature, specimens of 3 inches×3 inches were cut from the dry film and placed on the perforated lid of a 2′×1′×1′ (45 L) efflorescence test chamber facing downward. One half of the chamber was filled with clean tap water, and the water temperature inside the chamber was maintained at 70° F. using a small water heater to create sufficient water vapor inside the chamber. The specimens were constantly exposed to the water vapor to induce efflorescence on the exposed surface.

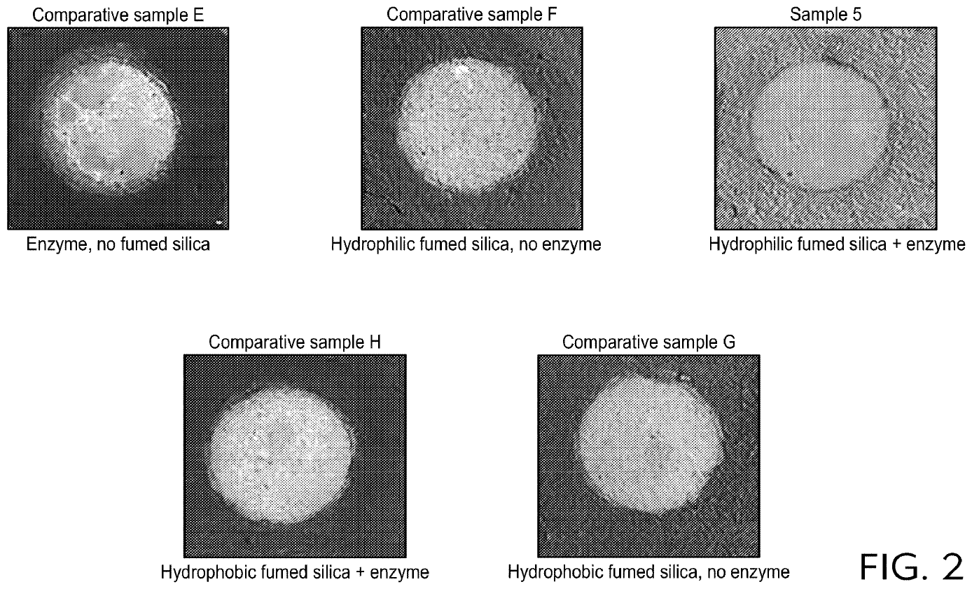

The efflorescence test chamber was placed inside a temperature-controlled environmental chamber, with the temperature of the environmental chamber maintained at 40° F. This accelerated the formation of efflorescence on the surface of the specimens. The specimens remained undisturbed in this set up for a week. After one week, the exposed specimens were removed from the efflorescence test chamber and left to dry at room temperature for 24 hours. The systems with efflorescence appear as white as a result of the formation of calcium carbonate on the surface of the specimen. Photographs of the specimens are shown in FIG. 2.

The efflorescence was quantitatively measured in terms of ΔE and ΔL values using a Datacolor Spectro 1000 spectrophotometer. Higher ΔE and ΔL values correspond to higher efflorescence. The ΔE and ΔL values for the specimens are reported in Table 3 below.

TABLE 3

| | Carbonic | | | |
|---|---|---|---|---|
| | Anhydrase | Fumed Silica | ΔE | ΔL |
| Comparative Sample E | Yes | None | 17.23 | 22.95 |
| Comparative Sample F | No | Hydrophilic | 12.62 | 14.73 |
| Comparative Sample G | No | Hydrophobic | 12.47 | 15.04 |
| Comparative Sample H | Yes | Hydrophobic | 17.21 | 21.66 |
| Sample 5 | Yes | Hydrophilic | 4.57 | 3.04 |

As shown in FIG. 2 and Table 3, in view of comparative samples E & F and sample 5, the cementitious composition which included both carbonic anhydrase and hydrophilic fumed silica demonstrated a strong synergistic effect in the reduction of efflorescence.

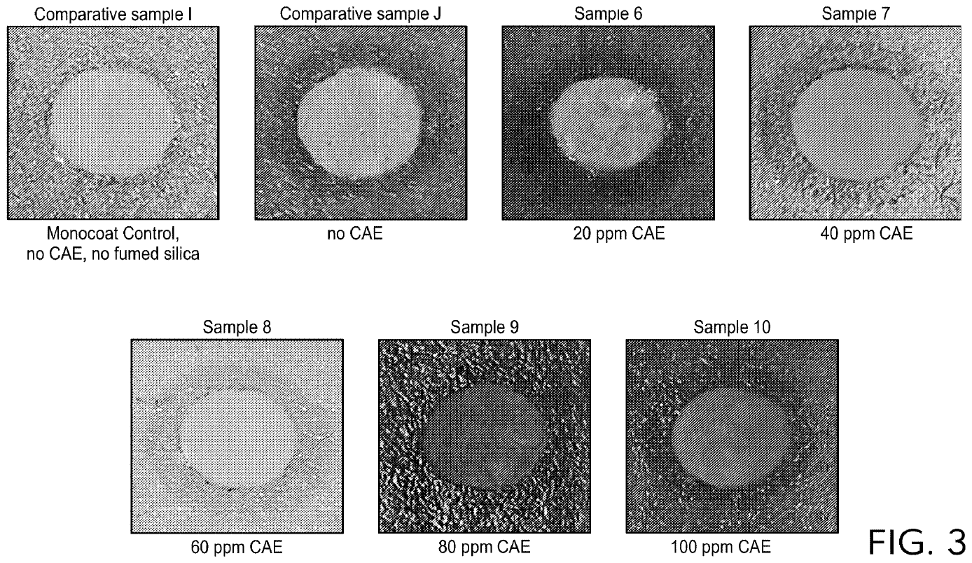

Next, the enzyme loading was varied while hydrophilic fumed silica loading remained constant (in accordance with the loading of Example 1) to determine the effect on efflorescence mitigation. The specimens were prepared as described previously in this example, but the amount of carbonic anhydrase varies from 0 in the comparative samples and between 20 ppm and 100 ppm in the demonstrative examples. The carbonic anhydrase loading, the ΔE values, and the ΔL values are provided in Table 4 below. Photographs of the samples are provided in FIG. 3.

TABLE 4

| | Carbonic | | | | |
|---|---|---|---|---|---|
| | Anhydrase | | Fumed Silica | ΔE | ΔL |
| Comparative Sample I | 0 | ppm | None | 10.85 | 4.85 |
| Comparative Sample J | 0 | ppm | Hydrophilic | 7.41 | 3.19 |
| Sample 6 | 20 | ppm | Hydrophilic | 7.77 | 3.57 |
| Sample 7 | 40 | ppm | Hydrophilic | 2.22 | −0.66 |
| Sample 8 | 60 | ppm | Hydrophilic | 3.84 | 1.22 |
| Sample 9 | 80 | ppm | Hydrophilic | 4.92 | 1.71 |
| Sample 10 | 100 | ppm | Hydrophilic | 4.85 | 0.74 |

Based on delta E and delta L values of comparative sample J and sample 6 in Table 4 and FIG. 3, at greater than 20 ppm carbonic anhydrase enzyme, combination of hydrophilic fumed silica and carbonic anhydrase enzyme demonstrated a strong synergistic effect in mitigating efflorescence.

### Example 3

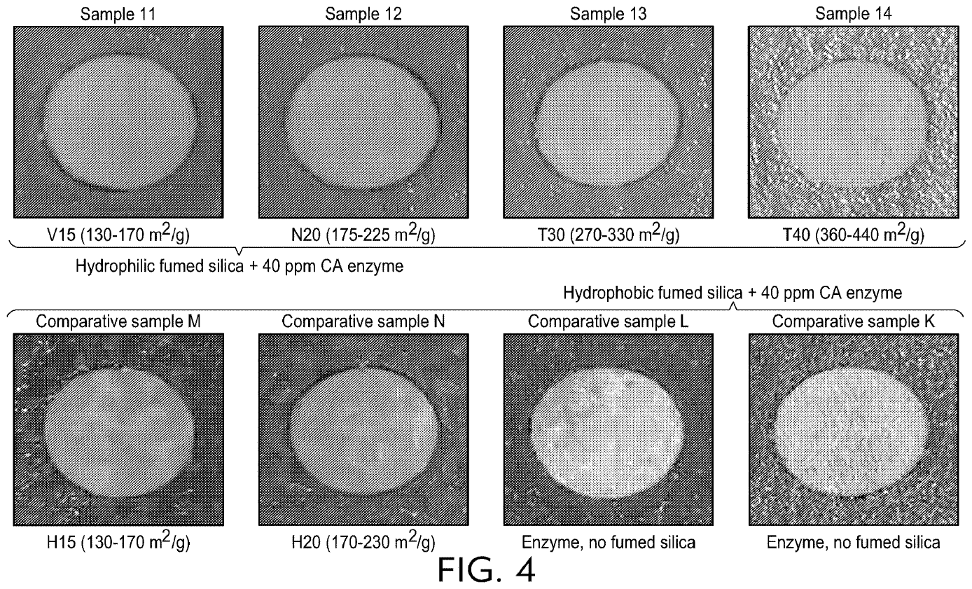

Cementitious compositions having various grades of hydrophilic fumed silica were evaluated to determine whether the synergistic effect of the hydrophilic fumed silica and carbonic anhydrase was related to the surface area of the fumed silica. Comparative examples were also evaluated including two different grades of hydrophobic fumed silica with different surface areas. Compositions were prepared as described above in Example 1, including carbonic anhydrase loaded at 40 ppm. The results are provided in Table 5 below. Photographs of the samples are provided in FIG. 4.

TABLE 5

| | Carbonic | | Surface Area | | | Open Time | Dry Time |
|---|---|---|---|---|---|---|---|
| | Anhydrase | Fumed Silica | (m²/g) | ΔE | ΔL | (min) | (h) |
| Comparative | 0 ppm | None | — | 11.00 | 11.24 | — | — |
| Sample K | | | | | | | |
| Comparative | 40 ppm | None | — | 13.15 | 16.00 | — | — |
| Sample L | | | | | | | |
| Comparative | 40 ppm | Hydrophobic | 130-170 | 8.95 | 9.44 | 78 | 5+ |
| Sample M | | | | | | | |
| Comparative | 40 ppm | Hydrophobic | 170-230 | 7.08 | 5.99 | 81 | 5.5 |
| Sample N | | | | | | | |
| Sample 11 | 40 ppm | Hydrophilic | 130-170 | 3.06 | 2.24 | 28 | 3.5 |
| Sample 12 | 40 ppm | Hydrophilic | 175-225 | 3.06 | 2.29 | 20 | 2.5 |
| Sample 13 | 40 ppm | Hydrophilic | 270-330 | 3.34 | 2.87 | 18 | 3.0 |
| Sample 14 | 40 ppm | Hydrophilic | 360-440 | 3.55 | 3.07 | 20 | 4.0 |

As shown in FIG. 4 and Table 5, for hydrophilic fumed silica (Samples 11-14), the reactivity of the fumed silica is the predominant factor in mitigating efflorescence, and not the surface area. However, for hydrophobic fumed silica (Comparative Samples M and N), increased surface area did have an impact on mitigating efflorescence. Additionally, when comparing hydrophilic versus hydrophobic fumed silica with similar surface areas, hydrophilic fumed silica performed significantly better in mitigating efflorescence.

The open times and dry times indicate the reactivity of the compositions in the plastic state during curing of the cementitious compositions. When open times and dry times are compared within hydrophilic and hydrophobic fumed silica categories, there is a discernible difference in reactivities between the two groups. In particular, open and dry times for compositions including hydrophobic fumed silica (Comparative Samples M and N) are significantly longer than those for compositions including hydrophilic fumed silica (Samples 11-14). This reconfirms that the carbonic anhydrase is catalyzing the reaction of exposed hydroxyl groups in the hydrophilic fumed silica with the cementitious mixture, thereby reducing efflorescence.

### Example 4

Comparative cementitious coating samples were prepared following the procedure in Example 1 except the fumed silica was replaced with alternate hydrophilic additives. The weight percent of the hydrophilic additives was kept constant at 1% based on the total weight of the cementitious dry mix. Carbonic anhydrase amount was maintained at 40 ppm.

The efflorescence test was performed on the dry cementitious coating samples by following the procedure described in Example 2. The open time, dry time and ΔE and ΔL values of these samples incorporating alternate hydrophilic additives are listed in Table 6 below.

TABLE 6

| | Carbonic | | | | | |
|---|---|---|---|---|---|---|
| | Anhydrase | | | | Open Time | Dry Time |
| Sample# | (ppm) | Hydrophilic Additive | ΔE | ΔL | (min) | (h) |
| 11 | 40 | Fumed Silica | 3.21 | 2.54 | 20 | 3.0 |
| 15 | 40 | Silica Fume | 10 | 10.36 | 40 | 4.0 |
| 16 | 40 | Precipitated Silica | 4.08 | 3.33 | 20 | 3.0 |
| 17 | 40 | Magnesium Hydroxide | 8.19 | 7.43 | 45 | 5.0 |
| 18 | 40 | Zinc Sulfate | 9.51 | 10.12 | 155 | 7.0 |
| 19 | 40 | Sodium Sulfate | 4.95 | 5.95 | 31 | 3.0 |
| 20 | 40 | Magnesium Sulfate | 4.73 | 3.98 | 2 | 2.5 |

Among the alternate hydrophilic additives, precipitated silica was the closest in comparison to fumed silica in terms of mitigating efflorescence in cementitious coatings in the presence of carbonic anhydrase enzyme.

### Example 5

To obtain further insight, the specimens prepared in Example 2 (Comparative Samples E-H and Sample 5) were analyzed using x-ray diffraction (XRD), scanning electron microscopy with energy dispersive spectroscopy (SEM-EDS), and x-ray microscopy (XRM).

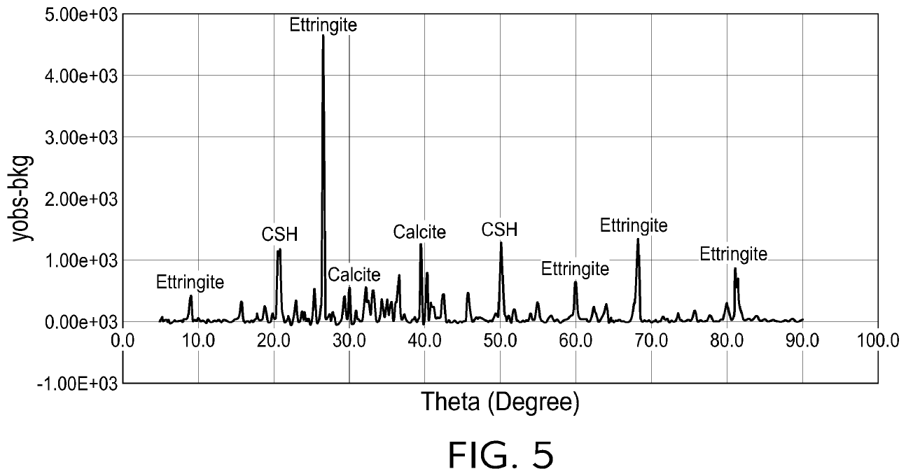

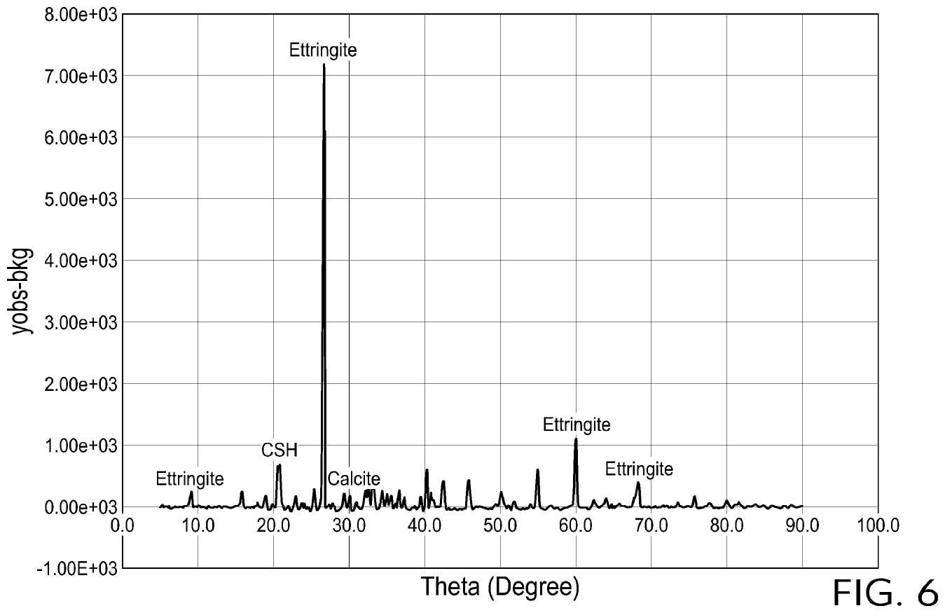

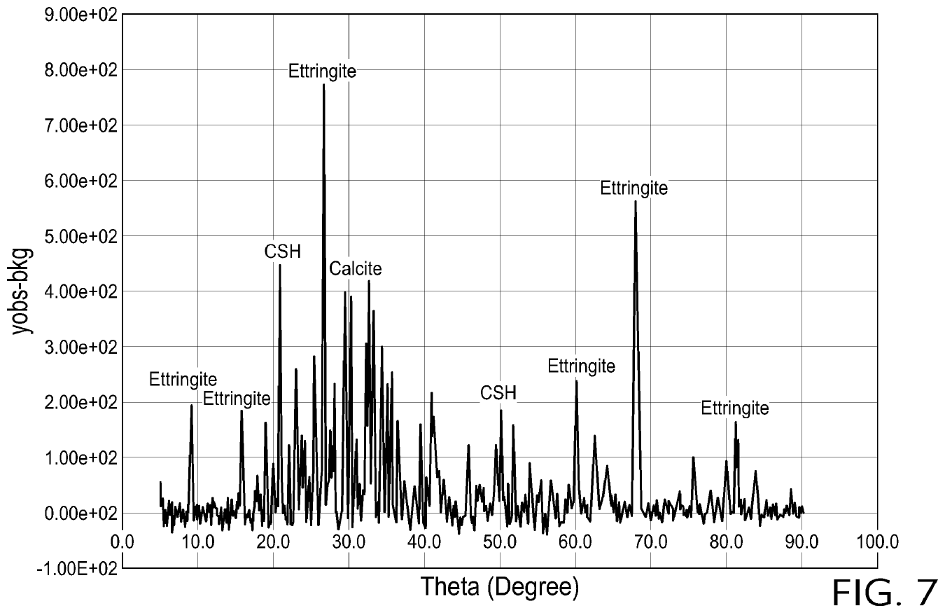

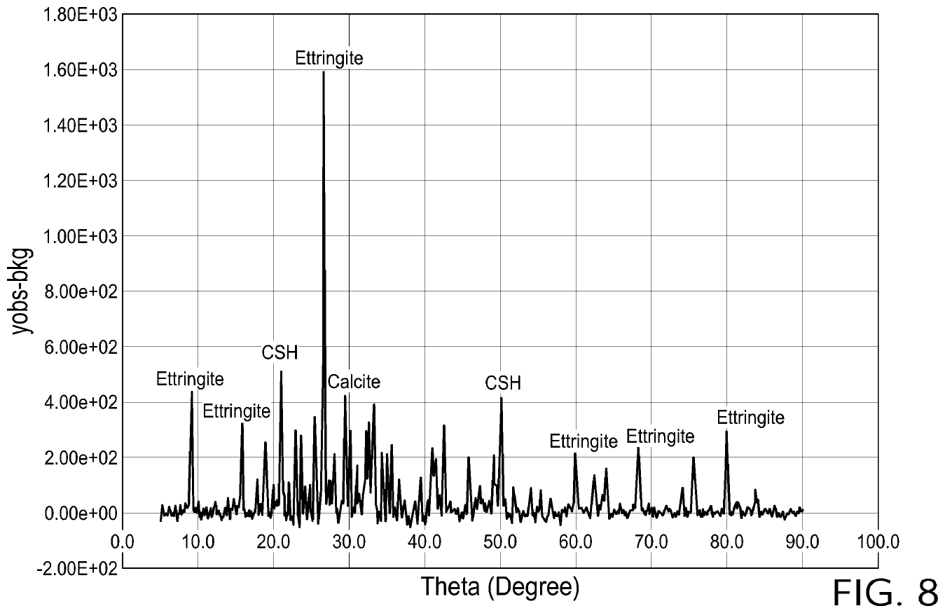

X-ray diffraction of the powder form of dry, unexposed specimens (e.g., after troweling the cementitious compositions onto the EPS and dried for 24 hours) was performed on a Rigaku Ultima IV x-ray diffractometer with access to ICDD crystalline structure database and incorporating cross-beam optics technology. XRD measures the intensity of the diffracted x-rays as a function of the angle of incidence. The resulting diffractogram is characteristic of the material. In particular, the position of the peaks is characteristic of the interatomic distances and the relative peak intensities depend on the atomic number of the atoms in each position. XRD analysis of Comparative Samples E-H and Sample 5 are provided in FIGS. 5-9, respectively.

Ettringite or hydrated calcium aluminum sulfate hydrate is a primary constituent in the hydration of cement. It is a normal reaction product of the hydration of tricalcium aluminate with gypsum (calcium sulfate) incorporated in cement dry mix to prevent flash setting. This reaction to form ettringite takes place within the first few hours of cement hydration and contributes to early strength development of cured cement. Ettringite formation plays an important role in the control of setting during cement hydration process. Ettringite crystals have a needle-like morphology.

The primary role of carbonic anhydrase is to catalyze the reaction of carbon dioxide from air with water soluble calcium hydroxide to form calcite during cement hydration. Calcite forms both cubic and spindle type crystals.

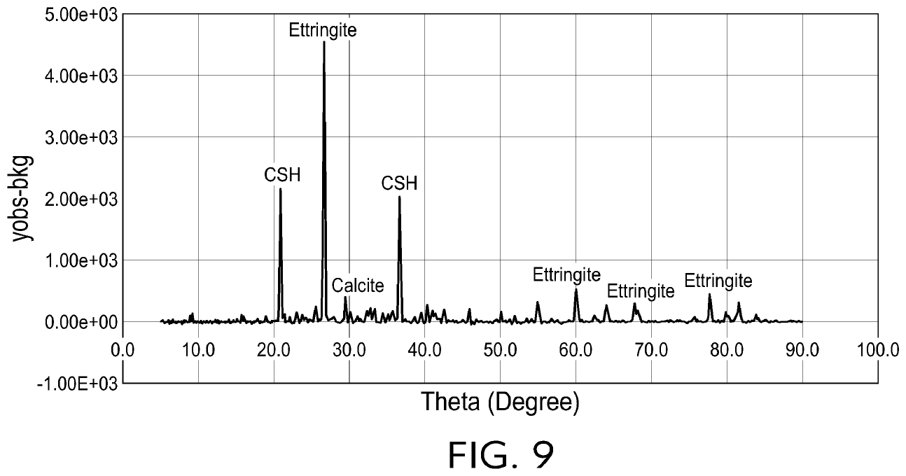

Since ettringite is a primary species formed during cement hydration, the peaks assigned to ettringite in XRD spectra seem to be prevalent in all cement specimens analyzed by XRD. When the cement contains carbonic anhydrase without any fumed silica, more calcite formation is evident as shown in FIG. 5. What is notable in cement containing a combination of hydrophilic fumed silica and carbonic anhydrase (Sample 5) is that in addition to ettringite peaks, calcium silicate hydrates (CSH) peaks are more pronounced, as shown in FIG. 9. Without being bound by theory, it is believed that the carbonic anhydrase is catalyzing the reaction of hydrophilic fumed silica with calcium ions present in cement to form calcium silicate hydrates which tend to plug the pores and capillaries of cementitious matrix which would then contribute to mitigate efflorescence by preventing the incoming and outgoing of water from cured cement.

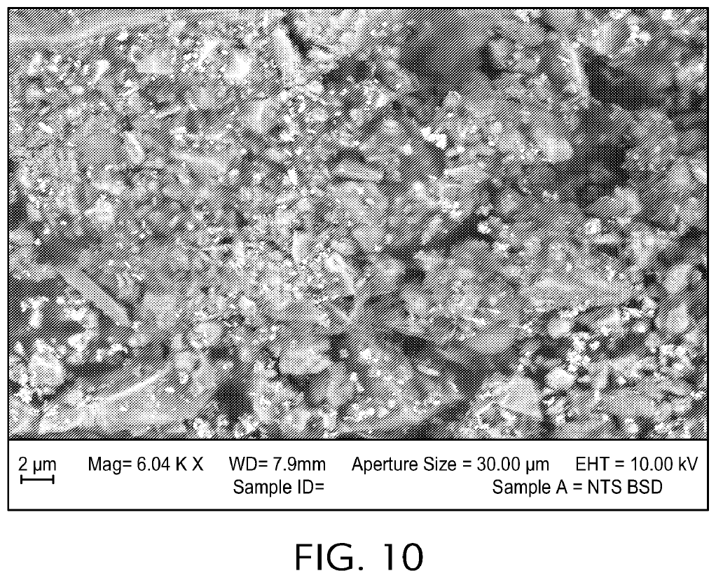

SEM-EDS was conducted on a Zeiss Sigma VP field emission SEM with a 10 kV imager, a variable pressure of 20 Pa, and a backscattered detector. Images were acquired at 500×, 2000×, and 6000×. In SEM, an electron beam is rastered along the sample surface and the emitted signal is collected. The emitted signal can be secondary electrons, backscattered electrons, or characteristic emitted x-rays. The images in FIGS. 10-14 correspond to the backscattered electron signal (BSE). In BSE detection, brighter pixels in the image typically correspond to higher atomic numbers. SEM images of Comparative Samples E-H and Sample 5 are provided in FIGS. 10-14, respectively.

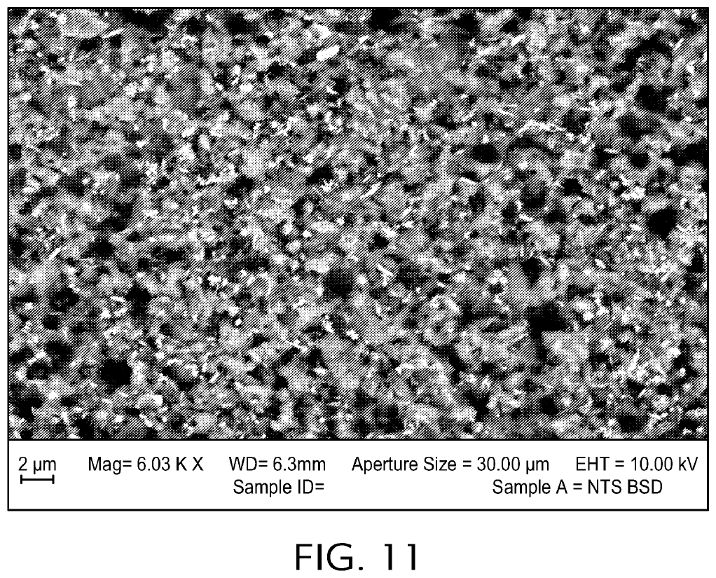

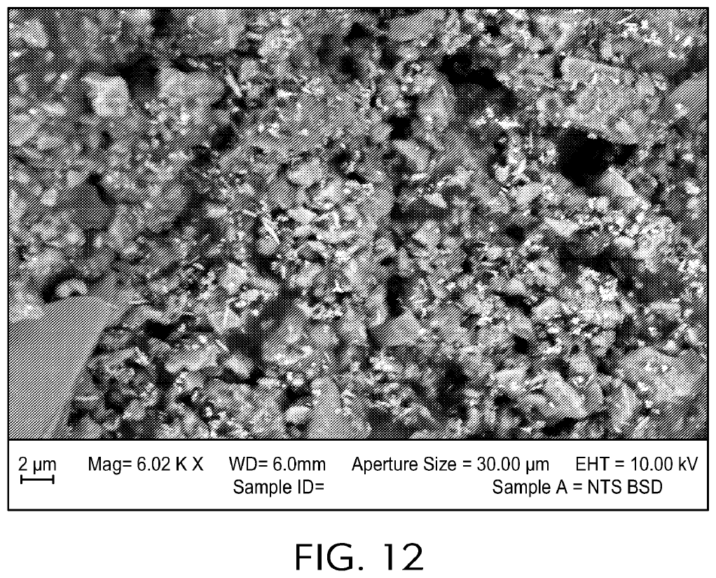

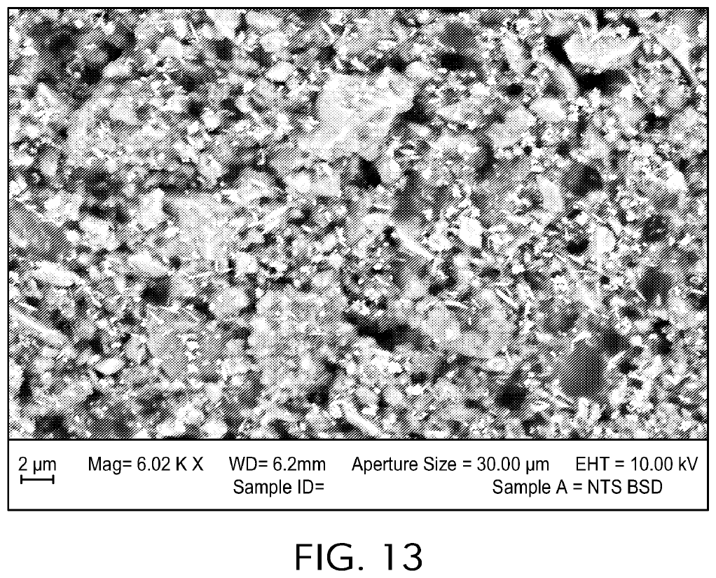

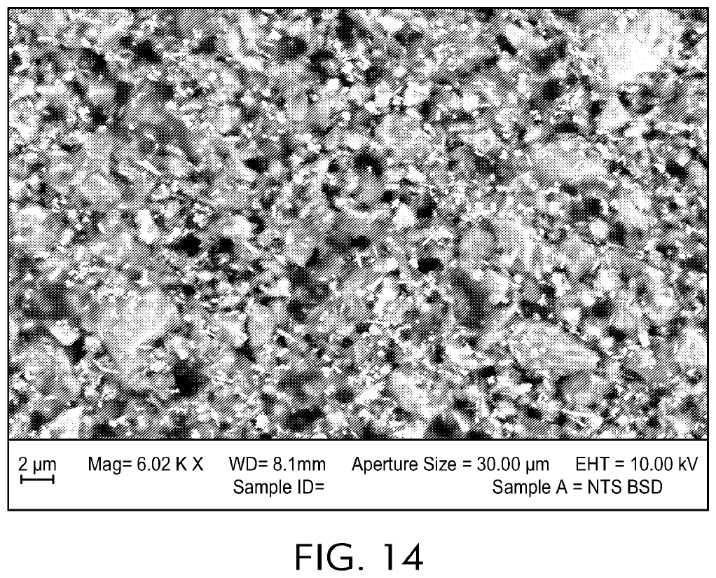

Since ettringite is a primary constituent in the hydration of cementitious composition, needle-like crystals of ettringite can be observed in all of the SEM images. Comparing the SEM images of the cementitious composition with carbonic anhydrase and no fumed silica (Comparative Sample E) with the one with hydrophilic fumed silica and no enzyme (Comparative Sample F), the presence of more calcite crystals with cubic morphology in FIG. 10 (Comparative Sample E) as opposed to FIG. 11 (Comparative Sample F) can be observed. This is presumably due to catalytic activity of the carbonic anhydrase to form more calcite in Comparative Sample E. The presence of fumed silica by itself in the cementitious composition does not promote calcite formation. In the SEM image of the cementitious composition that has both hydrophilic fumed silica and carbonic anhydrase (Sample 5) as presented in FIG. 14, more tubular structures can be observed, presumably due to CSH as determined by EDS analysis, in addition to cubic calcite crystals and needle-like ettringites. FIGS. 12 and 13 are SEM images of cementitious compositions containing hydrophobic fumed silica without (Comparative Sample G) and with enzyme (Comparative Sample H), respectively.

Next, XRM was carried out using a Zeiss Xradia Versa. XRM settings were 4× objective, bin 2, 2.4 μm pixel size, 80 kV, 10 V, 2 second exposure LE5 filter, and 3001 projections. XRM uses an x-ray beam to image samples based on differences in density. Transmission of the x-rays through the sample is measured by the detector and used to generate an image. The instrument rotates a sample and acquires a series of images that are then combined to create a 3-dimensional image. The 3D image can be divided into different regions of interest (a process called segmentation) using Dragonfly, a computer software designed for image analysis. In Dragonfly, a machine learning algorithm is taught to identify pixels as part of the pore of the ceramic matrix. Once identified, the software can then be used to calculate the percentage of the total pixel volume that has been labelled as a pore. Porosity data generated by XRM on unexposed cementitious specimens are presented in Table 7 below.

TABLE 7

| | Porosity (%) |
|---|---|
| Comparative Sample E | 25.37 |
| Comparative Sample F | 22.81 |
| Comparative Sample G | 29.52 |
| Comparative Sample H | 30.00 |
| Sample 5 | 20.53 |

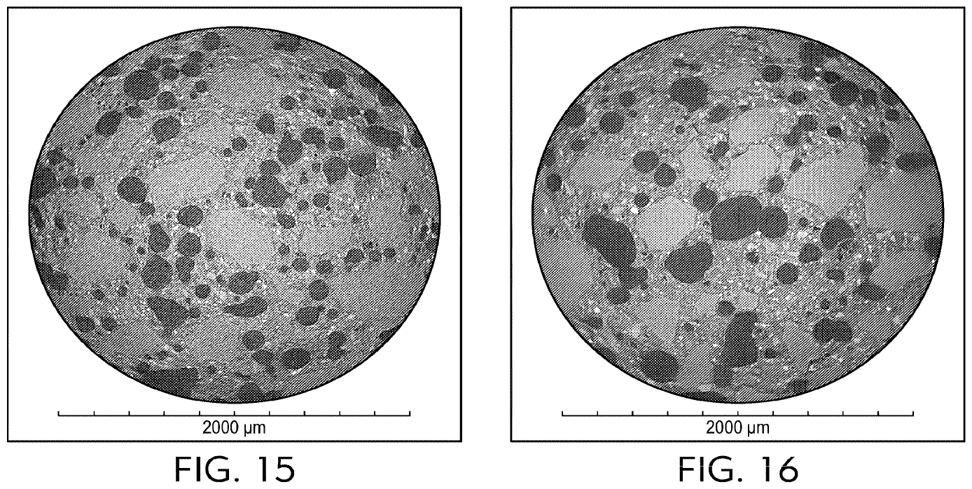

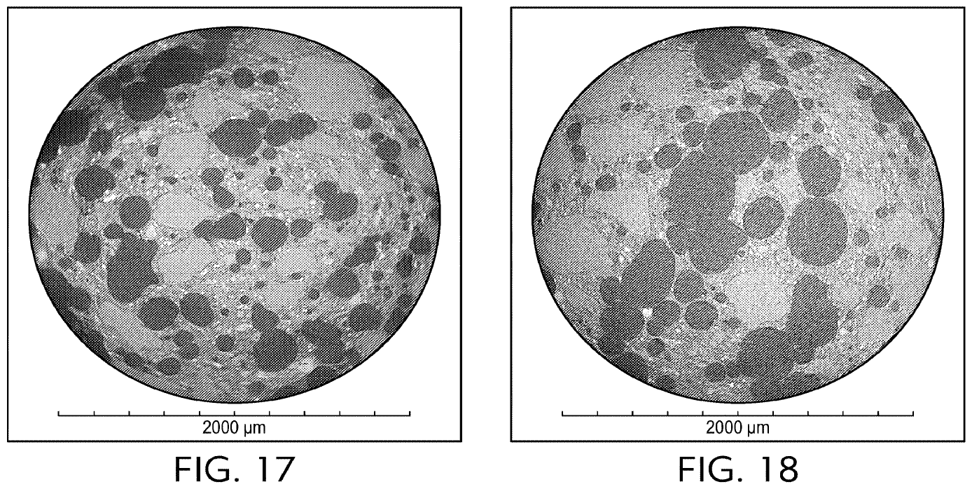

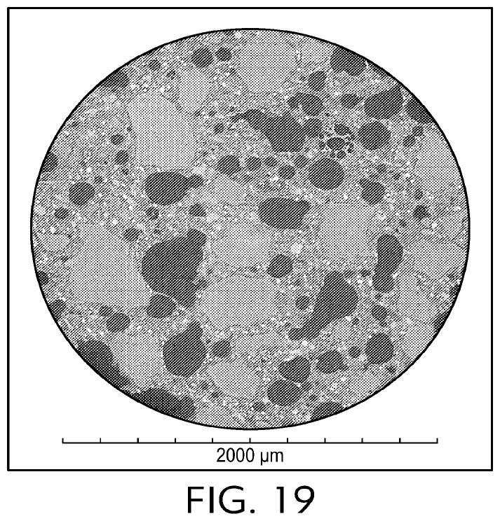

XRM images for Comparative Samples E-H and Sample 5 are provided in FIGS. 15-19. Brighter spots in the images are areas that have a higher density as compared to the region around it. The darker spots in the images correspond to pore spaces. Segmentation and quantification of the pore volume is based on the 3D image generated during XRM analysis.

From both the quantitative measurement of porosity (Table 7) and the physical appearance of dark spaces that represent pores, the specimen with hydrophilic fumed silica and carbonic anhydrase demonstrated lowest % porosity (Sample 5). This strongly supports the efflorescence test results demonstrating significant reduction of efflorescence in the cementitious compositions containing hydrophilic fumed silica and carbonic anhydrase. This further demonstrates that the synergistic effect between hydrophilic fumed silica and carbonic anhydrase produces species that plug the pores and capillaries of cement matrix and reduce porosity.

Although only a few embodiments of this invention have been described above, it should be appreciated that many modifications can be made without departing from the spirit and scope of the invention. All such modifications are intended to be included within this invention, which is to be limited only by the following claims.

1. A cementitious dry mix comprising:
a Portland cement;
a calcium aluminate cement;
a calcium sulfo-aluminate cement;
an admixture comprising a hydrophilic additive; and
carbonic anhydrase.

2. The cementitious dry mix of claim 1, wherein the hydrophilic additive is selected from the group consisting of hydrophilic: precipitated silica, fumed silica, silica fume, magnesium hydroxide, lithium hydroxide, sodium sulfate, zinc sulfate, magnesium sulfate, and combinations thereof.

3. The cementitious dry mix of claim 1, wherein the hydrophilic additive is hydrophilic fumed silica.

4. The cementitious dry mix of claim 1, further comprising an aggregate.

5. The cementitious dry mix of claim 4, wherein the aggregate is present in an amount of from 30 wt. % to 80 wt. % based on a total weight of the cementitious dry mix.

6. The cementitious dry mix of claim 1, wherein the carbonic anhydrase is present in an amount of from 0.1 ppm to 1000 ppm based on a total weight of the cementitious dry mix.

7. The cementitious dry mix of claim 1, wherein the hydrophilic additive is present in an amount of from 0.1 wt. % to 20 wt. % based on a total weight of the cementitious dry mix.

8. A cementitious composition comprising the cementitious dry mix of claim 1, and further comprising from about 15 wt. % to about 40 wt. % water of hydration based on the total weight of the cementitious dry mix.

9. The cementitious composition of claim 8, wherein the cementitious composition has an open time of less than or equal to about 120 minutes.

10. The cementitious composition of claim 8, wherein the cementitious composition has a dry time of less than or equal to about 8 hours.

11. A cured cement product formed from a cementitious dry mix comprising:
a Portland cement;
a calcium aluminate cement;
a calcium sulfo-aluminate cement;
an admixture comprising a hydrophilic additive; and
carbonic anhydrase.

12. The cured cement product of claim 11, wherein the hydrophilic additive is selected from the group consisting of hydrophilic: precipitated silica, fumed silica, silica fume, magnesium hydroxide, lithium hydroxide, sodium sulfate, zinc sulfate, magnesium sulfate, and combinations thereof.

13. The cured cement product of claim 11, wherein the hydrophilic additive is hydrophilic fumed silica.

14. The cured cement product of claim 11, wherein the cementitious dry mix further comprises an aggregate.

15. The cured cement product of claim 14, wherein the aggregate is present in an amount of from 30 wt. % to 80 wt. % based on a total weight of the cementitious dry mix.

16. The cured cement product of claim 11, wherein the carbonic anhydrase is present in an amount of from 0.1 ppm to 1000 ppm based on a total weight of the cementitious dry mix.

17. The cured cement product of claim 11, wherein the hydrophilic additive is present in an amount of from 0.1 wt. % to 20 wt. % based on a total weight of the cementitious dry mix.

18. The cured cement product of claim 11, wherein the cured cement product has a porosity of less than about 21%.

19. The cured cement product of claim 11, wherein the cured cement product exhibits reduced efflorescence as compared to a cured cement product made from a cementitious composition that does not include the hydrophilic additive, the carbonic anhydrase, or both, but is otherwise identical.

20. The cementitious dry mix of claim 4, wherein the aggregate comprises sand.
